(19) United States
(12) Patent Application Publication
(10) Pub. No.: US 2008/0298269 A1
(43) Pub. Date: Dec. 4, 2008

(54) METHOD AND DEVICE FOR BUFFERING DATA PACKETS TRANSMITTED VIA A PLESIOCHRONOUS SIGNAL

(75) Inventors: Yannick STEPHAN, Tregastel (FR); Michel LOUARGANT, Lannion (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL LUCENT, PARIS (FR)

(21) Appl. No.: 12/128,614

(22) Filed: May 29, 2008

(30) Foreign Application Priority Data
May 30, 2007 (FR) 0755324

(51) Int. Cl. H04L 12/26; H04J 3/06

(52) U.S. Cl. 370/252; 370/235; 370/516

(57) ABSTRACT

The device for buffering packets emanating from a sending source (1) over a communication network (3) comprises recording means capable of recording elements obtained from the received packets into a buffer memory (8). The buffering device further comprises measurement means (9, 10, 11, 12) capable of measuring the difference between the bit rate of the incoming packet stream and the bit rate at the output of the buffer memory, and, if the bit rates are equal, said recording means are capable of recording the elements received in standard mode with an adaptive buffering threshold whose value varies within a limited range, whereas if they are unequal, the recording means are capable of recording in free mode with an adaptive buffering threshold whose value varies within a free range in such a way as to gradually compensate for said difference.

This invention pertains to buffering data packets transmitted between a sending entity and a receiving entity via a plesiochronous signal, in which said sending and receiving entities use clocks which are independent of one another.

It may generally be applied in devices that function according to IP protocol (“Internet Protocol”), and more specifically in devices that receive streams (audio, video, and or data), such as terminals, bridges, gateways, or elements of a network that supports voice over IP (VOIP).

Generally speaking, in the receiving entity, a memory unit organized in a First In, First Out fashion (FIFO) makes it possible to compensate for network jitter received in the incoming packet stream in order to restore a stream with a constant bit rate at the output of the memory unit.

As a reminder, network jitter is a variable delay caused in any asynchronous communication in packet mode. In the packet receiver, it may lead both to gaps (or “starvation”, a lack of a signal to be restored, as the packet arrives too late) and to overflow (meaning that it exceeds the storage capabilities of the memory unit).

One of the known techniques for managing jitter is the use of adaptive buffering thresholds whose value may vary along a range defined by a minimum point and a maximum point. The value of the threshold is increased (without exceeding the upper limit of the range) when the jitter observed in the receiver is greater than the programmed threshold. Its value is reduced (without exceeding the lower limit of the range) when the jitter observed in the receiver is less than the programmed threshold.

Such a jitter management mechanism is not satisfactory for plesiochronous communication.

In fact, when applied to plesiochronous communication, the jitter management mechanism leads to a need for ongoing compensation in the same direction (towards the lower or upper limit, depending on the situation). The compensation limit will inevitably be exceeded. For this reason, if the threshold limits are abided by, the threshold will no longer be suitable. The result of this is periods of starvation or overflow, whose frequency depends on the difference between the bit rate of the packets entering the buffer memory and the bit rate at the output of the buffer memory.

No current solution takes into account the effect caused by this clock shift between the sending and receiving entities of a plesiochronous signal.

The present invention remedies this drawback.

It relates to a method for buffering digital data packets emanating from a sending source over a communication network, in which elements obtained from the received packets are recorded in a buffer memory.

According to one general definition of the invention, the difference between the bit rate of the input packet stream and the bit rate of the packet stream at the output of the buffer memory is measured, and if the bit rates are equal, the elements received with an adaptive buffering threshold that varies along a limited range are recorded in standard mode, whereas if they are unequal, the elements are recorded in free mode with an adaptive buffering threshold that varies within a free range defined with no minimum or maximum points, in such a way as to compensate for said difference.

For this reason, in the presence of a call coming from a plesiochronous signal, such as the one functioning using IP protocol, the method of the invention has the advantage of putting into place a packet recording mechanism that can remove the drawbacks arising from clock shift between the two ends of a plesiochronous signal.

In particular, the method of the invention makes it possible to gradually compensate for the lack or access of packets in the buffer memory resulting from clock shift between the two ends of a plesiochronous signal.

In one embodiment, the measurement of the difference in bit rates is constantly carried out at a selected pace.

In practice, the adaptive buffering threshold is a number of recorded elements.

For example, the buffer memory operates according to FIFO.

Another subject of the present invention is a device for buffering digital data packets emanating from a sending source across a communication network, comprising recording means capable of recording elements obtained from the received packets into a buffer memory.

Another aspect of the invention is that the buffering device further comprises measurement means capable of measuring the difference between the input packet stream and the output packet stream, and if the bit rates are equal, said recording means are capable of recording the elements received in standard mode with an adaptive buffering threshold whose value varies within a limited range, whereas if they are unequal, the recording means are capable of recording the elements in free mode with an adaptive buffering threshold whose value varies within a free range in such a way as to compensate for said difference.

Other characteristics and advantages of the invention shall become apparent upon examining the detailed description below, and the drawings, in which:

FIG. 1 schematically and functionally depicts a part of the communication network in which the invention is being applied;

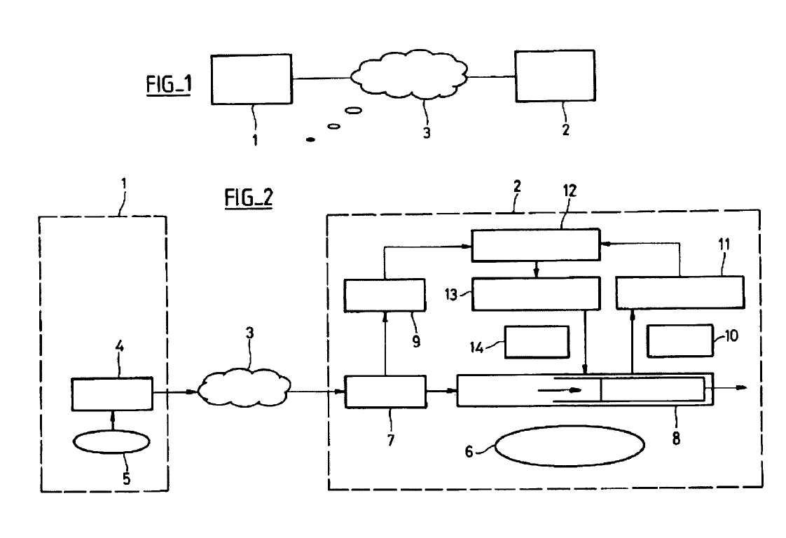

FIG. 2 is a diagram depicting in detail the elements that make up a sending entity and a receiving entity that implement the method of the invention; and

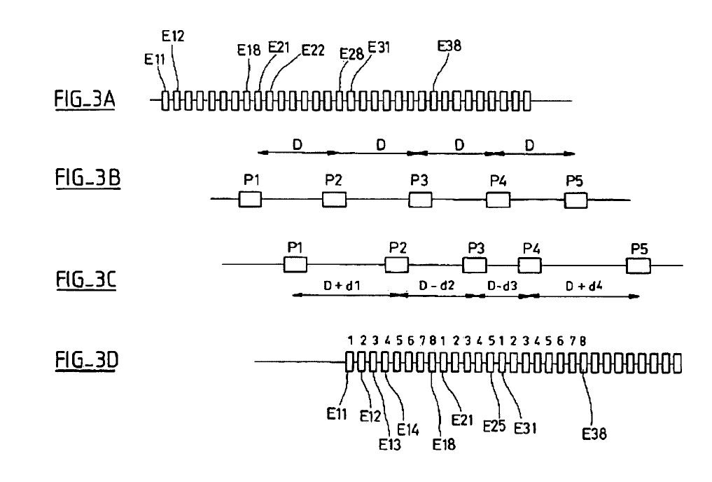

FIGS. 3A to 3D are time charts depicting the method of the invention. FIG. 1 shows a situation in which a telephone call is made between a sending entity 1 (the caller) and receiving entity 2 (the recipient of the call) over a communication network 3. The communication protocol may, for example, be IP protocol.

The sending entity 1 may, for example, be a user of a mobile communication network connected to the network 3 via a “trunk gateway” (not shown). The receiving entity 2 may, for example, be a user connected to the IP network 3 via a network card and a modem (not shown).

Naturally, the invention is not limited to this scenario; rather, it applies to any communication network that uses a packet transport protocol.

In FIG. 2, the sending entity 1 includes a data packet generator 4 timed to a local clock 5. The bit rate of the samples Eij prior to packetization is shown in FIG. 3A.

In FIG. 3B, the packets P coming from the sender 1 (individually numbered from P1 to P5) are separated from one another by a constant interval D.

We now return to FIG. 2.

The receiving entity 2 includes a local clock 6, distinct and independent from the sending clock 5.

The receiver 2 includes an interface 7 that implements IP, UDP, and RTP protocols to receive IP packets and extract their content.

A buffer memory 8 receives packets from the interface 7. The buffer memory operates according to FIFO (“First In, First Out”).

In FIG. 3C, the stream of packets P is shown at the input of the memory 8. The interval between two packets P is not constant; rather, it varies depending on the network jitter. For example, the interval between packets P1 and P2 is equal to D+d1, where d1 is an additional period of time resulting from the network jitter. This interval between P2 and P3 may, for example, be equal to D−d2, where d2 is a period of time that is different and distinct from D2.

In FIG. 3D, the elements Eij are depicted at the output of the memory 8. It is seen that samples S26, S27, and S28 are missing, due to the adaptive threshold used by the prior art mentioned above.

Surprisingly, the Applicant has observed that in the context of a plesiochronous call, is desirable to remove the limits of the range within which the adaptive buffering threshold of the memory 8 may vary.

Owing to this removal of limits, the starvation and overflowed periods in the presence of a plesiochronous call are anticipated, and are compensated accurately without any negative impact on voice quality.

In this manner, the memory 8 is equipped with a mechanism that will detect the presence of a plesiochronous call, i.e. the presence of a difference between the input packet stream bit rate and output packet stream bit rate of the buffer memory.

If they are equal, the memory 8 records the elements received in standard mode with an adaptive buffering threshold whose value varies within a limited range. This recording is done based on known, conventional recording rules for a FIFO memory.

On the other hand, if they are unequal, the elements are recorded into the memory in free mode with an adaptive buffering threshold whose value varies within a free range (i.e. an unlimited range, also called a “free run,”) in such a way as to compensate for the difference between the bit rate of the packets sent/received and the bit rate at the output of the buffer memory.

To measure this difference, two measurement operations are to be conducted, with one consisting of measuring the bit rate of the incoming packet stream, and the other consisting of measuring bit rate at the memory output.

In practice, the first measurement is made by first measurement means 9 capable of processing information found in the transport layers of the network, such as the RTP layers, in order to deduce from them the network's difference.

The second measurement operation is advantageously conducted independently of the source. For example, it may rely upon the analysis of the average number of samples available in the memory output. The second operation is thereby conducted based on observing the bit rate of the output of the buffer memory, with no information from the source.

To conduct the second operation, reading means 10 read the buffering level and inform the second measurement means 11 of the level read in this manner.

Processing means 12 receive information from the first measurement means 9 and second measurement means 11 in order to deduce from them the difference between the input packet stream bit rate and the memory output bit rate, and deduce from them whether or not a plesiochronous call is present.

If a plesiochronous call is detected, the processing means 12 adjust (13) the buffering threshold level freely (a “free run”), with no upper or lower limits.

In practice, the adaptation means 13 modify (through writing 14) the level of adaptive buffering based on the difference measured in this manner. This adaptation is not limited by a maximum or minimum point as normally used in prior solutions, or used when the call is not identified as plesiochronous.

Such an absence of limits in the range of threshold values makes it possible to gradually compensate for the difference between the bit rate of the packets sent and the bit rate of the packets at the memory output.

Preferably, the measurement of the difference is conducted on an ongoing basis, at a selected pace, such as depending on the arrival of the packets or the amount of memory that is full.

1. A method for buffering digital data packets emanating from a sending source (1) sent over a communication network (3), in which elements obtained from the received packets are recorded in a buffer memory (8), characterized in that the difference between the bit rate of the incoming packet stream and the bit rate at the output of the buffer memory is measured, and if said bit rates are found to be equal, the elements received are recorded in standard mode with an adaptive buffering threshold whose value varies within a limited range, whereas if said bit rates are found to be unequal, the elements are recorded in free mode with an adaptive buffering threshold that varies within a free range in such a way as to compensate for said difference.

2. A method according to claim 1, in which the difference in bit rates is measured on an ongoing basis, at a selected pace.

3. A method according to claim 1, in which the buffering threshold is a number of recorded elements.

4. A method according to claim 1, in which the buffer memory (8) operates according to FIFO.

5. A device for buffering digital data packets emanating from a sending source (1) over a communication network (3), comprising recording means capable of recording elements obtained from the received packets into a buffer memory (8), characterized in that it further comprises measurement means (9, 10, 11, 12) capable of measuring the difference between the bit rate of the incoming packet stream and the bit rate at the output of the buffer memory, and, if the bit rates are equal, said recording means are capable of recording the elements received in standard mode with an adaptive buffering threshold whose value varies within a limited range, whereas if they are unequal, the recording means are capable of recording the elements in free mode with an adaptive buffering threshold whose value varies within a free range in such a way as to gradually compensate for said difference.
